(19) United States
(12) Patent Application Publication
(10) Pub. No.: US 2025/0370790 A1
(43) Pub. Date: Dec. 4, 2025

(54) METHOD FOR ENABLING OBJECT ABSTRACTION IN SERVERLESS CLOUD COMPUTING SYSTEM

(71) Applicant: UNIVERSITY OF LOUISIANA AT LAFAYETTE, Lafayette, LA (US)

(72) Inventors: Mohsen Amini SALEHI, Lafayette, LA (US); Pawissanutt Lertpongrujikorn, Lafayette, LA (US)

(73) Assignee: UNIVERSITY OF LOUISIANA AT LAFAYETTE, Lafayette, LA (US)

(21) Appl. No.: 18/680,042

(22) Filed: May 31, 2024

(51) Int. Cl. G06F 9/48; H04L 67/10

(52) U.S. Cl. CPC G06F 9/4843; H04L 67/10

(57) ABSTRACT

A method and system on top of the function resources that not only mitigates the burden of resource management, but also mitigates the burden of data management from the developer's perspective. The method and system may incorporate a new abstraction level in serverless computing, known as Object as a Service (OaaS). Incorporating the application data into the object abstraction can unlock opportunities for built-in optimization features, such as data locality, data reliability, caching, software reusability, and data access control. Like object-oriented programming, objects in OaaS offer encapsulation and abstraction benefits on top of the function abstraction. Moreover, objects in OaaS enable developers to transparently define workflows of functions (a.k.a. dataflow programming) in the cloud.

### CROSS REFERENCE TO RELATED APPLICATIONS

This application claims benefit of priority under 35 U.S.C. § 119(e) of U.S. Ser. No. 63/470,009, filed May 31, 2023, titled “Method for Enabling Object Abstraction in Serverless Cloud Computing Systems” the entire contents of which is incorporated herein by reference in its entirety.

### STATEMENT REGARDING FEDERALLY SPONSORED RESEARCH OR DEVELOPMENT

The invention was made in part with United States Government support by Grant No. NSF 2047144 from the National Science Foundation. The United States Government therefore has certain rights in this invention.

### FIELD OF THE INVENTION

The field of the invention relates to cloud asset data management, specifically the modification of Function as a Service to allow for unified storage of data and functions in the same system.

### BACKGROUND OF THE INVENTION

Function-as-a-Service (FaaS) paradigm is becoming widespread and is envisioned to be the next generation of cloud computing systems that mitigates the burden for programmers and cloud solution architects. The FaaS paradigm allows the developer to implement a set of independent functions that are transparently provisioned in isolation on the cloud infrastructure. Major public cloud providers offer FaaS services and several open-source platforms for on-premises FaaS deployments are emerging too. FaaS offers the function abstraction that allows users to develop their business logic and invoke it with a predefined trigger. Functions can be pipelined and form a workflow. A function in the workflow generates an event that triggers another function. However, for larger workflows, configuring and managing the chain of events become complex and adds a burden to the developer. Function orchestrator services set to mitigate this burden for the developers.

On the back end, the serverless platform hides the complexity of resource management details and deploys the function in a seamless and scalable manner. In particular, the platform enables FaaS to be truly pay-as-you-go via scale-to-zero and charging the user only upon a function invocation. FaaS is proven to reduce the development and operation costs, thus, is in alignment with modem software development paradigms, such as CICD and DevOps. A variant of FaaS, called Container as a Service (CaaS), does not offer the function development framework, and the user has to provide the platform with the already containerized functions.

As the FaaS paradigm is primarily centered around the notion of stateless functions, it naturally does not deal with the data. Thus, the developers have to intervene and undergo the burden of managing the application data using separate cloud services. That is, although FaaS makes the resource management details (e.g., load balancing and scaling) transparent from the developer's perspective, it does not do so for the data. Even though stateless functions make the system scalable and manageable, the state still exists in the external data store and the developer must intervene to connect the running service to the data store. For instance, in a video streaming application, in addition to developing the functions, the developer has to maintain the video files, their metadata, and manage the access to them.

Apart from the data aspect, current FaaS systems do not offer any built-in semantic to limit the access to the internal (a.k.a. private) mechanics of the functions. However, providing unrestricted access to the developer team has known side-effects, such as function invocation in an unintended context, and data corruption via direct data manipulation. To overcome such side-effects, developers again need to intervene and undergo the burden of configuring external services to enable access control.

### SUMMARY OF THE INVENTION

To overcome these inherent problems of FaaS, disclosed is a method and system on top of the function resources that not only mitigates the burden of resource management, but also mitigates the burden of data management from the developer's perspective. The method and system may incorporate a new abstraction level in serverless computing, known as Object as a Service (OaaS). Incorporating the application data into the object abstraction can unlock opportunities for built-in optimization features, such as data locality, data reliability, caching, software reusability, and data access control. Like object-oriented programming, objects in OaaS offer encapsulation and abstraction benefits on top of the function abstraction. Moreover, objects in OaaS enable developers to transparently define workflows of functions (a.k.a. dataflow programming) in the cloud.

An example embodiment provided is a cloud-based video streaming system that needs developers to rapidly implement new streaming services for the available video contents. A few examples of such services are as follows: Generating multilingual subtitles for the safety-related videos; Removing harmful and illicit contents from the child-safe video contents; Developing a face detection service on the videos. In these examples, the services have to deal with the video files, and developing them using FaaS entails the developers manage the data by their own. In this context, the OaaS paradigm can mitigate the developer's job by offering the built-in encapsulation semantic. The video files are defined as objects that persist their state and are bound to a set of functions that can be invoked by the viewer's application and potentially change the object (video) state. For instance, the request to generate Chinese subtitles for a given video object invokes the subtitle (Chinese) function of that particular object.

The core components of the OaaS platform that collectively provide the notion of “object”. The developer can deploy a cloud-based application by declaring the application structure in the form of a set of classes and functions to the OaaS platform, and the platform automatically deploys the functions using the container technology and Knative (the existing serverless solution). Upon the function invocation by the user, OaaS translates the request into one or more tasks containing the application state data and then forwards it to the developer function. In this approach, the developer function executes the task in a stateless manner and produces the modified state as an output of the task execution. The altered state is returned to OaaS to be persisted in the data store.

As seen in FIG. 1B, OaaS segregates the state management from the developer's source code and incorporates it into the serverless platform to make it transparent from the developer's perspective. In this case, the object's function only includes the business logic and upon invocation, the OaaS platform executes the function that is authorized to persist the object state (via internal API calls). In addition to enabling encapsulation of the function and state to form the object abstraction, the OaaS platform offers templates (analogous to the notion of class in OOP) to developers that can simplify defining properties and functions of the object(s). Note that the object abstraction is not a replacement for FaaS, instead, it is a complement for it. There are use cases that are naturally stateless (e.g., mathematical functions) and the function is the appropriate abstraction to develop them.

To reduce the overhead, the OaaS platform comprises a data tiering mechanism that diminishes the latency of accessing the object. The tiering mechanism makes use of a key-value database to store the object specifications (a.k.a. metadata) that are accessed frequently, in addition to an in-memory caching to accelerate accessing the infrequently-updated but frequently-accessed metadata (e.g., class and function specifications). OaaS also reduces unnecessary data movements within the platform via employing a redirection mechanism, instead of relaying (transferring) the object state.

To maintain scalability, the OaaS is based on the micro-services architecture and with the minimum contention between the self-contained services. OaaS also minimizes the object state synchronization by implementing the immutable data processing model. That is, upon invoking a function of an object the OaaS platform outputs a new/updated object state, instead of updating the existing one. Implementing this semantic makes the function perform a stateless operation and keep the state consistent without synchronization, thereby, appearing stateful at the high level. Thus, the OaaS platform provides stateful objects with the minimal overhead, while maintaining the serverless characteristics.

### BRIEF DESCRIPTION OF THE DRAWINGS

The drawings constitute a part of this specification and include exemplary embodiments of the METHOD FOR ENABLING OBJECT ABSTRACTION IN SERVERLESS CLOUD COMPUTING SYSTEMS, which may be embodied in various forms. It is to be understood that in some instances, various aspects of the invention may be shown exaggerated or enlarged to facilitate an understanding of the invention. Therefore, the drawings may not be to scale.

FIG. 1A provides a flow chart of a FaaS-based system. In FaaS, the developer has to implement both the application logic and the state management and deploy them in form of function(s) that interact with the developer-provisioned cloud storage service.

FIG. 1B provides a flow chart of an OaaS system. In contrast to FaaS, in OaaS, the developer only has to implement the application logic and deploy it as an object with built in state management service.

FIG. 2 provides the architecture of OaaS that manages the objects within the serverless cloud system. The dashed lines represent the workflow of actions taken by the developer and the solid lines represent those for the end user.

FIG. 3 is an example script that declares a class, named test1, and a function for it, named concat, in the YAML format.

FIG. 4 is a rendering of the data modeling of the object in the OaaS platform. The top part shows different types of data OaaS has to handle for an object. The bottom section shows the data tiering scheme developed in an OaaS based on the size and access frequency of the data.

FIG. 5A is a flow chart showing the flow of interactions between the OaaS components for developing a class and deploying its function(s).

FIG. 5B is a flow chart showing the flow of interactions between the OaaS components for invoking a function of an object by the end user.

FIG. 6A is a bar graph showing the average execution time (vertical axes) for transcoding on a video object with varying state sizes (horizontal axes) on the Knative and OaaS platforms. For the OaaS platform, FIGS. 6(A) and 6(B) report the average execution time in three circumstances: the full version; with the data tiering disabled; and with both data tiering and URL redirection disabled (shown as OaaS with no optimization).

FIG. 6B is a bar graph showing the average execution time (vertical axes) for concatenations on a text object with varying state sizes (horizontal axes) on the Knative and OaaS platforms.

FIG. 7A is a bar graph showing the latency overhead imposed during transcoding on a video object due to the concurrent function calls on the objects. Video transcoding represents the compute-intensive behavior.

FIG. 7B is a bar graph showing the latency overhead imposed during concatenations on a text object due to the concurrent function calls on objects. Text concatenation represents data-intensive behavior.

FIG. 8 is a line graph evaluating the scalability of the OaaS platform against Knative. The horizontal axis shows the scale-up degree of the worker VMs and the vertical axis shows the speedup.

FIG. 9 is a flow chart showing a use case of developing a face detection workflow for a video.

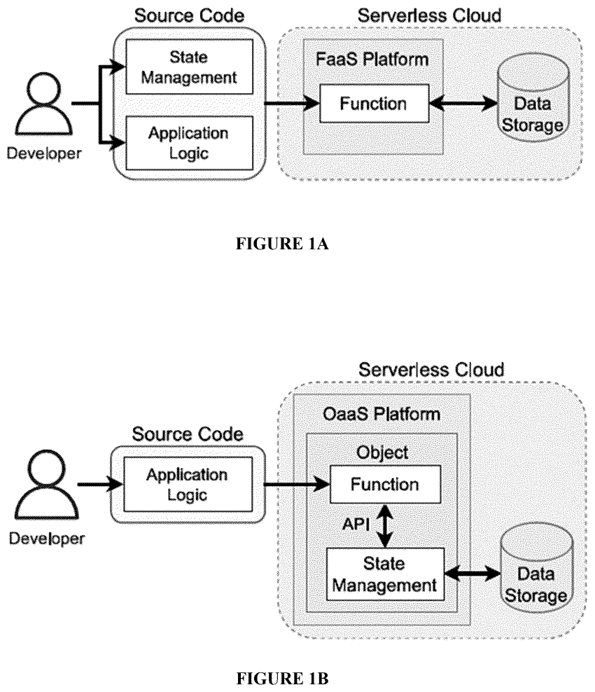

### DETAILED DESCRIPTION OF THE INVENTION

The disclosed invention, the Object as a Service (OaaS) paradigm, aims a providing functionality for developers to rapidly implement new services without getting involved in low-level details. To that end, two objectives must be achieved.

First, the object in OaaS can provide abstraction and encapsulation across data and functions in the cloud. Moreover, developing the notion of class is desired to provide a framework for defining a group of objects with the same characteristics. For instance, consider a video stream provider who is developing a streaming application for disabled viewers. Using the notion of class, he/she can define the accessible_videos class and assign all the accessibility functions to it (e.g., subtitle_generator (language) for deaf viewers; scene_descriptor 0 for blind viewers; and increase_contrast ( ) for color-blind users). Without the notion of class in place, the developer has to assign functions to each individual video file, which is tedious and error-prone, whereas using the class, he/she declares the class once, and defines several video files as the object instances of that class. In this manner, the notion of class provides a “type” for a set of objects that are otherwise untyped. Furthermore, the notion of class enables the developer to assign an access modifier to each function, thereby, realizing encapsulation and control the access to functions in different contexts.

Second, the OaaS must provide transparency in the application data (object state) management, and in defining a workflow of functions. Fulfilling this objective realizes the notion of Dataflow Programming that allows developer to define a workflow without getting involved in the concurrency and synchronization complexities. To allow the developer accessing an object in the workflow without the knowledge of its status (i.e., whether or not the object is instantiated in the workflow), the OaaS platform exposes the object access interface (“OAI”) that enables the developer to invoke a function, request the object state, or both in a single request. For instance, while the first user is invoking the increase_contrast ( ) function for video1 and the new object (video2) is being created in the output, the second user can invoke the scene_descriptor ( ) function on video2 and the OaaS platform handles the ordering of the invocations transparently.

In OaaS, an object may be an immutable entity with a state (i.e., data) associated with one or more functions. The state may be the application data that can be a file or a group of files on the cloud. Each function may correspond to a task upon invocation that can take action on the state. Note that, the function can have one or more objects as its input, however, it cannot modify them. Each object is instantiated from a class and is bound to the set of functions and state(s) declared in that class.

To enable higher-level abstractions for the users or developers, the OaaS platform allows combining (nesting) multiple objects into one. The high-level object holds a reference to the lower-level object(s), and the invoked function can leverage the reference to fetch the lower-level object as the input. Moreover, it is possible that the high-level object implements a new function (called macro function) and invoke a chain of functions from the lower-level objects. The major difference of macro functions with other works known in the art is that, macro functions introduce the flow of execution via the flow of data (state), rather than the invocation order. Given this data-flow semantic and immutable nature of the objects, the execution flow in a macro function is determined by the flow of data and the developers only need to introduce the flow. Then, in the background, OaaS takes care of the concurrency and synchronization, and guarantees the state consistency, regardless of the execution order.

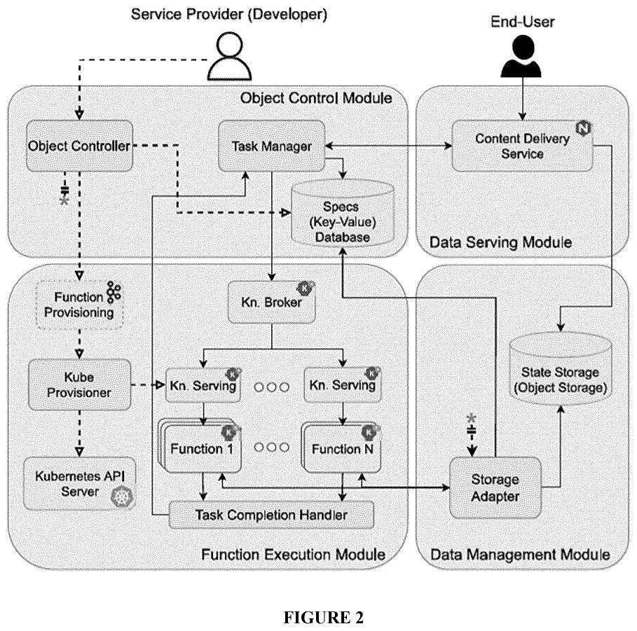

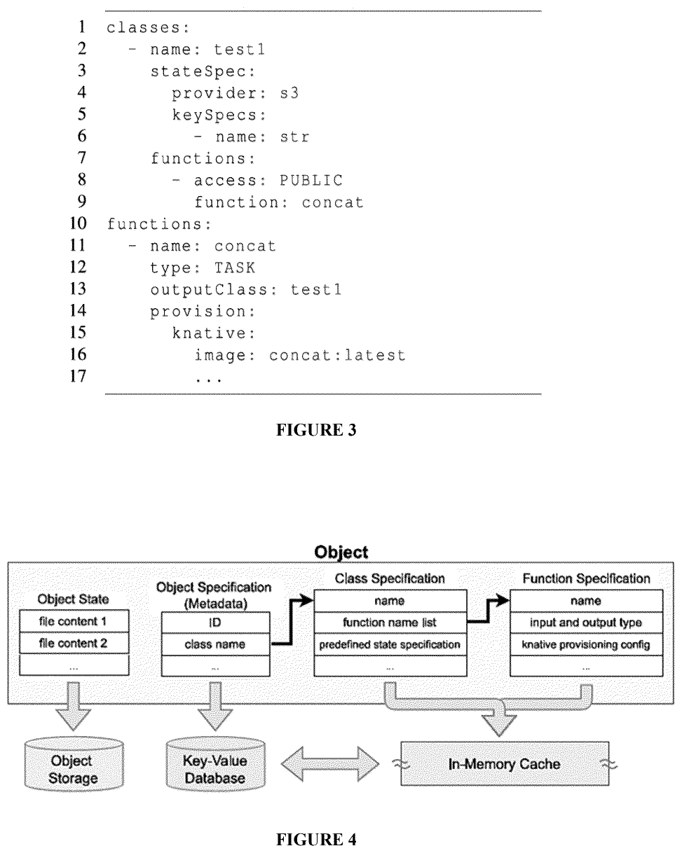

As shown in FIG. 2, OaaS supports two user scenarios: (a) the service provider (developer) who declares the class and its functions and develops objects for its application; and (B) the end user who accesses the objects (e.g., via an application or web front-end) and calls their functions via the object access interface. Declaring a new class and its functions in OaaS is achieved preferably using the YAML (or JSON) format. FIG. 3 is a listing representing a declaration example for a class called test1 that has a state named str (Line 6) and a function named concat. The specifications of the function are declared in Lines 10-16. The type of a function (Line 12) can be a task (or a macro, as discussed later). Because objects in OaaS are immutable, Line 13 specifies that the output of the function is another object instance of type test1. Lines 14-16 specifies the deployment configuration of the function, and Line 16 specifically declares the function container image URI.

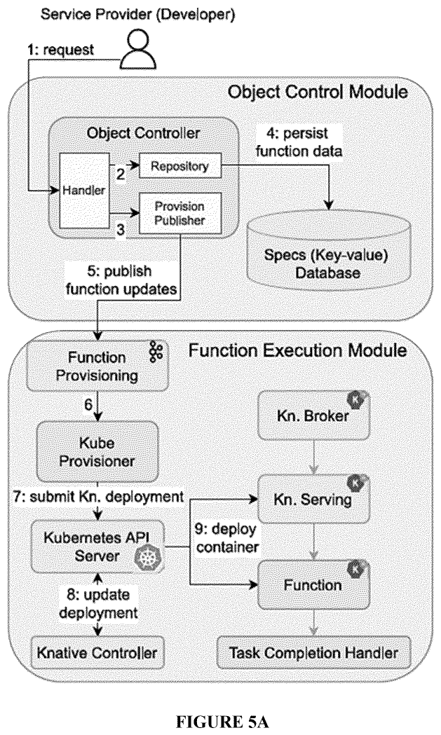

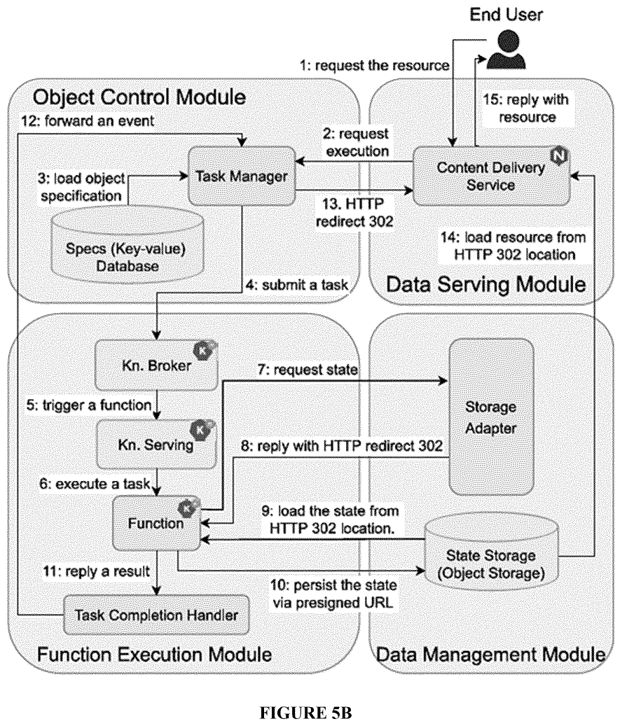

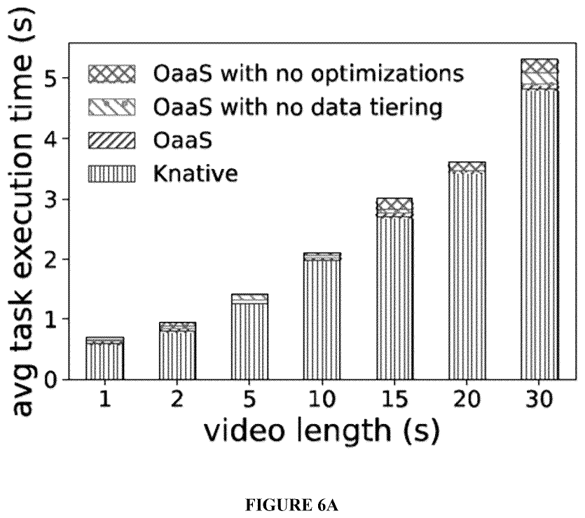

The OaaS platform is designed based on multiple self-contained microservices communicating over the network in a serverless cloud system. FIG. 2 provides a rendering of the OaaS architecture, and FIGS. 5(A) and 5(B) shows more details of the architecture by focusing on the interactions across the OaaS modules. The OaaS architecture is comprised of four modules: the Object Control Module, Function Execution Module, Data Management Module, and Data Serving Module. For illustrative purposes, the disclosure demonstrates how the system is built using Knative, which an open-source enterprise-level solution to build serverless and event driven applications. A person having ordinary skill in the art will however see that the disclosed system and method can be executed in similar serverless container systems.

The Object Control Module provides the interface for the objects to be managed (i.e., instantiated and updated) and used by the developer or the user. Upon invoking a function of an object, the module translates it to one (or more) task(s) in the system, and submits it (them) to the Function Execution Module. It also oversees the task(s) completion in the system. The Function Execution Module works with the serverless engine (e.g., Knative) to execute the task, and report the result back to the Object Control Module. It also deploys a developer-provided container in form of a function in the serverless system. The Data Management Module handles the state of objects and makes them available to the other modules of OaaS. The Data Serving Module acts as the end-user's interface and forwards his/her requests to the other modules.

OaaS has to deal with four types of persisted data for an object that it handles. Accessing such data frequently, if not handled properly, can cause a major slowdown of the platform. As such, the purpose of this data modeling is to design a scheme that can efficiently organize these different types of object data in OaaS, such that the system slowdown is minimized. The four types of data that have to be maintained are shown in the top part of FIG. 4. Object State is the actual data the object represents. Object Specification (metadata) defines characteristics of the object, including the object state URL, execution state, and class name (which is linked to the class specification data). Class Specification is the developer-provided information that serves as a template to introduce the attributes (state) and the functions for the objects of a specific class. Function Specification is the developer provided information describing the function signature (i.e., the type of inputs and output) and its deployment configuration (e.g., the function container URL that is accessible to OaaS).

As the Class and Function Specifications are common across objects, thus, are accessed more often than the object state that is the largest type of data in OaaS, and is only accessed upon the user demand or a function call to the associated object. Accordingly, one embodiment comprises object storage, which offers a low space-per-cost ratio, to persist the object state data. For other type of object data that are accessed more often and are smaller in size, a key-value database can be configured for persistence, which is faster and more efficient for frequent accesses.

Class and Function Specifications are frequently-accessed and infrequently-updated. They are both short in size and are common across multiple objects. These features make these types of data suitable for in-memory caching. So, as depicted in FIG. 4, the components of OaaS that deals with the Class and Function Specification data are configured to locally cache these data via an in-memory hash table that mirrors the key-value database.

The Object Control Module comprises an Object Controller, a Storage Adapter, and a Task Manager. The Object Controller offers the object and class abstractions to the developer. It specifies and manages the characteristics of the classes, objects, and functions within OaaS. It further exposes REST APIs that enable the developer to register and deploy the containerized functions within OaaS. The function registration involves validating the function specifications and persist them into a shared key-value database (called Specs Database in FIG. 2) to allow other OaaS components access them. Function deployment is the process of introducing the function container to the Kubernetes orchestrator. Upon validating the specification of a new function, it is forwarded into a function queue (known as Function Provisioning in FIG. 2 and implemented via Kafka Topic) to be later deployed on Kubernetes. The reason for handling function deployment asynchronously and transferring the function specification via the message queue is to guarantee that the specification is handled by the next component in the system and it is not affected by possible transient failures of the underlying system. The Object Controller is also responsible for creating objects in cooperation with the Storage Adapter. To create a new object, the developer submits the object specifications to the Object Controller and it calls the Storage Adapter to allocate a URL where the object state (e.g., video file) can be uploaded by the developer.

The Task Manager is primarily responsible for handling the function execution requests. It translates the function invocations into one (or more) task(s) and submit it (them) to the Function Execution Module where the Knative Broker routes the task(s) to the corresponding function container. The function call that is initially requested by the user is high-level and only includes basic information, such as the object ID, function name, and inputs. Task Manager receives the request and augments it with other information that are necessary to execute the desired function, including the URL of input object state, and the URL where the output object state shall be stored. Enabling macro functions and dataflow abstraction involves dealing with the concurrency and ordering of the functions' execution that is handled by the Task Manager. Upon receiving a macro function invocation, the Task Manager component generates the invocation graph as its internal state and uses it to coordinate ordering of the functions. For that purpose, upon receiving the task completion event (from the Task Completion Handler), the Task Manager readily generates the next task based on the invocation graph. In the case of a task failure, the Task Manager propagates the failure status to the dependent tasks in the invocation graph. Task Manager exposes the object access interface (OAI) to enable end-users transparently access the object's state and functions. OAI operates based on the web services and provides two modes of object access: synchronous mode and asynchronous mode.

Synchronous mode that is suitable for instantaneous function call use cases, and retrieving the object state. In this mode, the Task Manager holds the HTTP connection with the user application until the output object state is ready. For instance, let video1 be the identifier of a video object, transcode(var=int) one of its functions, and video2 be the output object. Then, a synchronous function call to the object is made in the form of: video1:transcode(var=1024)/video2.

Asynchronous mode is suitable for long (non-interactive) function execution use cases (e.g., macro function invocations). In this case, the Task Manager does not hold the HTTP connection, instead, responds immediately with the specifications of the prospective output object. The user application can use the specifications to check the object completion status at a later time. For instance, an asynchronous function call to the object of previous example is in the form of: video1:transcode(var=1024).

To reduce the latency of accessing output object state, the Task Manager avoids unnecessary data movements. To that end, it leverages the HTTP redirect mechanism to make the URL of the output object state, provided by the storage adapter, available to the Content Delivery Service. In that case, the output object state bypasses the Task Manager, and the Content Delivery Service can fetch the state in one hop and make it available to the user application.

With all these responsibilities of the Task Manager, it can potentially become the bottleneck of OaaS. To avoid that, the Task Manager can be designed to be scalable by making it stateless, hence, its container can be easily scaled out to multiple instances. The problem in making the Task Manager stateless is the “internal state” that it has to maintain to support macro functions. To handle this problem, the Task Manager can be configured to persist its internal state in the Specs Database.

The Function Execution Module comprises functionality for handling task execution and deploying functions. In handling task execution for a given function call on an object, the Object Control Module is in charge of converting it to task that is composed of a pointer to the object state and a function call. The Function Execution Module receives the created task, and takes care of its execution and successful completion. Schematic view of the steps taken to handle a function call is listed in FIG. 5(B).

An embodiment of the Function Execution Module utilizes Knative Broker, a component of Knative Eventing, to consumes the “task event” generated by the Task Manager in the Cloud Events format, and route the received task to the associated function container. In the next step, an auto-scaler (Knative Serving) is utilized to enable auto-scaling (and scale-to-zero) on the function container. It is noteworthy that the OaaS platform is modular and Knative can be replaced by other serverless engines without any major change to the other modules.

The Task Completion Handler component is in charge of tracking the function execution and forwarding the completion event to the Task Manager. Each function container includes an HTTP server to be able to handle the messages in the Cloud Events format. After executing a task, the HTTP server issues a 2xx status code, otherwise the task is deemed failed.

In addition to handling tasks, the Function Execution Module is in charge of deploying developer-defined functions. The key component of OaaS that is responsible for this is the translator, identified as a Kube Provisioner in the figures. As it is expressed in FIG. 5(A), Kube Provisioner receives a function deployment request (that includes function specifications) from the Function Provision component via subscribing to Kafka Topic. Upon receiving the request, Kube Provisioner translates the requested function specifications into the Kubernetes configuration format and forwards it to the API Server where the function container image is fetched from the registry (e.g., Docker Hub) and is deployed with the help of Knative Controller. This process makes the new function ready to be called (routed to) by the Knative Broker.

The Storage Adapter is primarily responsible for efficient and secure access to the object state. As shown in FIG. 2, it also communicates with the Specs Database to retrieve the class specifications it requires to verify authorized accesses to the object state.

Other components of OaaS that need to access the state of an object have to do it through the Storage Adapter. In one embodiment, the Storage Adapter works with a S3-compatible object storage system, however, in other embodiments, the adapter can be extended to support other storage types too (e.g., in-memory databases). To improve the efficiency of retrieving the object state data, Storage Adapter is designed to avoid unnecessary data movements. That is, instead of relaying state data to the requester component-because S3 protocol is HTTP-based-the Storage Adapter can employ the HTTP redirect mechanism and only send the URL of the state data to the requester. For that purpose, the Storage Adapter digitally sign the URL of the state data with a secret key to generate the authorized URL, and then puts it as the location field in the HTTP header. As such, the S3-presigned URL only grants access to the state data addressed by the URL. In this manner, the Storage Adapter preserves the object state security via preventing unauthorized access of a function to another object's state through learning its URL. Moreover, this mechanism decouples the object state storage from the function logic, such that in implementing a function, the developer does not need to know the storage details, such as the storage type, location, organization, and authentication.

For the Data Serving Module, the Content Delivery Service acts as a gateway to handle the object access request from the end-user. In one embodiment, it is implemented using the Nginx server with a specific configuration that enables load balancing across multiple instances of the Task Manager. In addition, the Content Delivery Service comprises a caching mechanism to increase the object access efficiency when multiple users request access to the same object. Recall that the synchronous-mode object access is replied by the Task Manager through HTTP redirection. Content Delivery Service explores the redirected location to retrieve the object state data from the storage. After that, the Content Delivery Service updates its local cache and replies to the user with the object state data.

To elaborate on the OaaS platform operations, in this part, further consider the flow of interactions between the OaaS components. Consider two main scenarios supported by the OaaS platform: (a) developing a class and deploying its function(s); and (b) invoking a function of an object by the end-user. For each scenario, FIG. 5 shows the involved components and the interaction steps.

As shown in FIG. 5(A), depicting the function deployment functionality, the developer initiates script to submit the specifications of a new function to the OaaS system. The Object Controller validates the specification and rejects it if it is invalid. Then, the Object Controller persists it into the Specifications Database and publishes a new specification into a message queue, called Function Provisioning, which may be implemented via Kafka Topics.

Kube Provisioner subscribes to the Function provisioning and upon receiving a new message from it, it generate the Knative resource definitions based on the new function specification, and submits it to the API Server. The Knative Controller subscribes to the API Server to synchronize its resources: the service container, broker, and trigger.

Function invocation occurs via the object access interface. As shown in FIG. 5(B), this scenario begins by the end-user invoking the function of an object and ends by receiving the output object state data. The Content Delivery Service handles the invocation by holding the connection and forwarding it to the Task Manager. Subsequently, the Task Manager validates the request, loads the related context (e.g., object, class, and function specification), generates the function execution task, and in then submits it to the Knative Broker. The Broker then routes the task to the requested Function container with the help of Knative Serving. The Function component solicits the object state from the Storage Adapter via the URL included in the task request. Then, the Storage Adapter redirects the request to the actual object state in the State Storage. Once the Function container receives the object state, it executes the function, produces the output object state, and persists it using HTTP PUT on the State Storage through the preassigned URL generated by the Storage Adapter. The Function informs the Task Completion Handler about the task completion status. Next, the Task Completion Handler forms a completion event and sends it to the Task Manager and that replies to the Content Delivery Service with the HTTP redirection to the output object state location. Ultimately, the content delivery service leverages the redirect location to retrieve the output object state from the State Storage and replies to the user.

To validate the disclosed method and architecture, the inventors deployed the OaaS platform on a cluster of virtual machines (VMs) allocated on local servers that include Dell® PowerEdge R380 and R840 machines with 10 Gbps fiber interconnect, collectively 160 processing cores, 760 GB memory, and 8 TB RAID storage. The cluster configured for the experiments includes three VMs with 16 vCPUs and 32 GB memory that have Kubernetes installed. Ceph is used as the data layer for the object storage. Infinispan is a distributed key-value database that we employed for the Specs Database. The OaaS platform was implemented using Java and the Quarkus framework.

As Knative is an increasingly popular platform that supports containerized functions, we use it as the baseline and compare the performance of OaaS against it. For both platforms, we use the same containerized functions. To make the containerized functions of Knative behave the same way as the OaaS functions, we create events (that mimics task events in OaaS) and feed them directly to Knative containers. In both cases, we use Gatling for load generation. We implemented two use cases to serve as the workload. Firstly, we developed a video transcoding using FFmpeg that is CPU-intensive and aligns with the motivation of this paper; Secondly, we develop a string concatenation function which is lightweight and only concatenates the content of a text file (i.e., the state) with another input string. The other characteristics of the workloads are specific to each experiment and are explained in the respective sections.

Although OaaS provides a high-level abstraction for the developers, it is not free of charge and imposes an overhead to the underlying system. As such, in this experiment, we focus on measuring its imposed overhead. Considering Knative as the baseline, we consider the extra latency of a function call in OaaS as the metric to measure overhead. We particularly study two sources of the overhead in OaaS: (a) The object state size, which highlights the overhead of OaaS in dealing with the stored data; and (b) The concurrency of the function invocation, which focuses on the overhead imposed by the OaaS platform itself.

We examine two objects: The first object has a one-second-long video file (as its state) and a transcoding operation, which exhibits a compute-intensive behavior, as its function. The second object has a text file (1.8 KB) as its state, and a function that concatenates the state contents with its input string (8 Bytes) argument. In this case, the processing time is only a fraction of the data loading time, hence, we consider it exhibiting a data-intensive behavior. We note that, in both cases, the functions persist their result as a new object state.

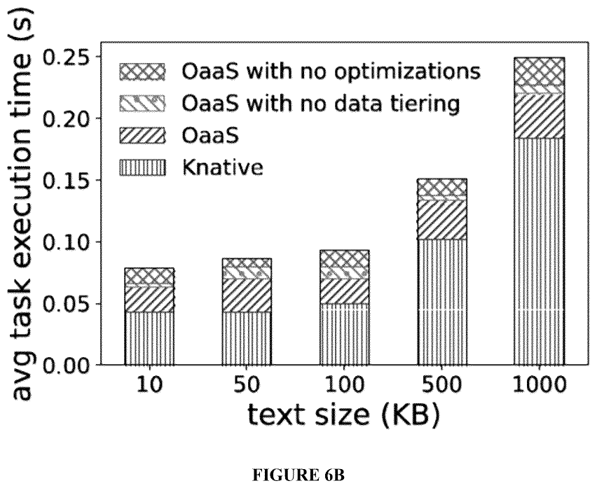

To measure the overhead of state data size, we conduct the experiment on both video and string objects with various state data sizes that are shown in FIGS. 6(A) and 6(B). To generate objects with various data sizes, we increase the input video length from 1-30 seconds. To assure that the examined videos have the same data size per video length ratio, the longer videos are generated from repeating the same content of the 1-second video. The resolution of the 1-second video is 1920×1080 and its size is 105 KB. Similarly, the text files for string concatenation have 10-1000 KB. For each object, we invoke the associated function and measure its completion time. On each worker VM, we configure two function containers (i.e., in total, 6 worker containers). To concentrate only on the overhead of data access and avoid other types of overheads, we configure Gatling to assign only one task per worker and set it to repeat this operation 30 times (hence, in total, 180 tasks are examined). To analyze the improvements offered by the URL redirection and data tiering, we examine three versions of OaaS: the full version; without data tiering; and without both URL redirection and data tiering (shown as OaaS with no optimization in FIGS. 6(A) and 6(B)). In this figure, the horizontal axes of both subfigures represent different state sizes for video and text, respectively, and the vertical axes represent the average task execution time (latency) in second.

The general trends in FIGS. 6(A) and 6(B) is that, in all cases, the average task execution time increases for larger object states. We observe that OaaS constantly imposes a slightly higher overhead (on average 0.03 seconds) than Knative. The low overhead is because of using the HTTP redirection and, to some extent, data tiering mechanisms to procure the object state to the function containers. The difference in the overhead of OaaS is more clearly visible in the text concatenation (FIG. 6(B)), but it is more disordered for video transcoding (FIG. 6(A)). This is because of the higher execution time and randomness of compute-intensive tasks that dominate the OaaS overhead time. The figures express that the URL redirection is more influential for the larger state sizes, whereas, the data tiering impact is abstract from the state size. In particular, we see that URL redirection and data tiering mechanisms collectively mitigate the overhead of OaaS on average by 73% for the video transcoding tasks and 43% for the concatenation tasks.

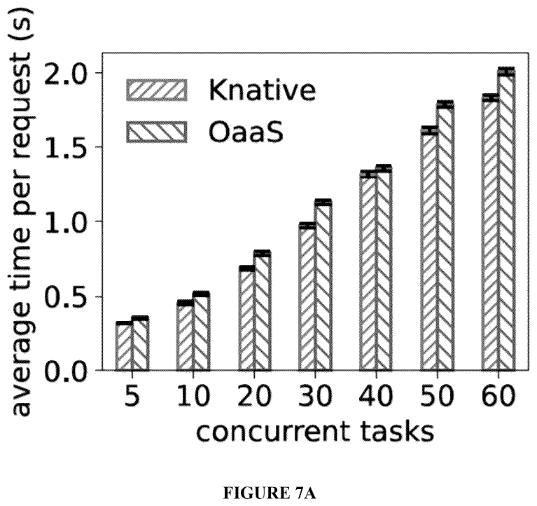

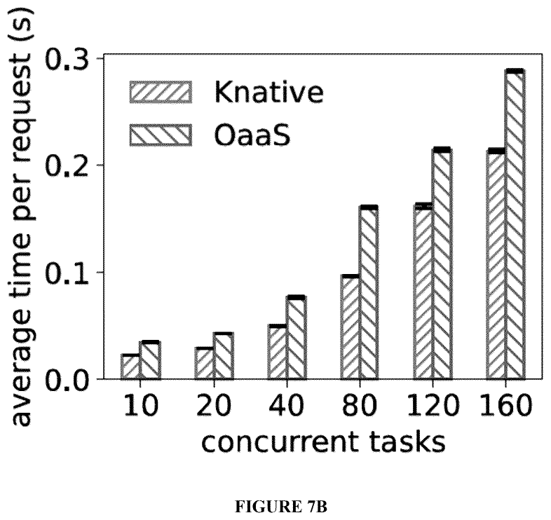

To measure the impact of concurrent function invocations on the imposed overhead of OaaS, we examine the two basic objects considered in the previous experiment too. To conduct this experiment, as shown in the horizontal axis of FIGS. 7(A) and 7(B), we increase the degree of concurrent tasks (function calls) on the same object, and measure the overhead in form of the average time it takes to complete a task (vertical axis). We observe that increasing the concurrency of invoking video transcoding function (FIG.(A)) does not raise the overhead by more than 0.2 seconds (for 60 concurrent calls), which is practically insignificant. In contrast, the difference is more noticeable for the string concatenation function (FIG. 7(B)) that grows by up to 27% when the degree of concurrency is 160. In analyzing the reason for the growth, we noticed the CPU is not fully utilized, hence, this not causing the slow down. To see if the bottleneck is because of the OaaS architecture, we conducted another experiment with the “no-op” function and observed a higher throughput than the concatenation function. This indicates that the the OaaS architecture has the capability of handling more concurrent tasks, hence, it is not the root cause for the bottleneck. By digging more, we realized that the performance difference between Knative and OaaS is because we submit the function calls directly to Knative Serving, whereas, in OaaS, the invocations pass through the Broker (see FIG. 2) that internally uses Kafka messaging system and persists messages into the storage, hence, slows down the system due to using more IOPS. The reason that we do not observe this overhead for video transcoding is its compute-intensive behavior that causes the processing time dominates the overhead. These results collectively show that although the OaaS platform comes with an overhead, the overhead becomes insignificant for more compute-intensive functions.

To study the scalability of OaaS, we deploy and evaluate it on the worker clusters with different sizes via scaling up the number of vCPUs on each one of the three worker VMs—from 4 to 32 vCPUs. That is, the total number of deployed cores ranges from 12 to 96 vCPUs. In each case, we deploy the two object functions: transcoding a video object and concatenating to a string object with the same settings as the previous experiment. We consider the speedup as the metric to measure the impact of scale-up. We assume that the scale-up degree of 4 vCPUs as the base that has the speedup value one, and the speedup of other scale-up degrees are calculated with respect to this base speedup value. Specifically, for each function in each scale-up degree, we find the maximum throughput (i.e., the number of tasks that are complete within one minute). Then, the speedup value of that scale-up degree is calculated relative to the throughput of the scale-up degree of 4 vCPUs.

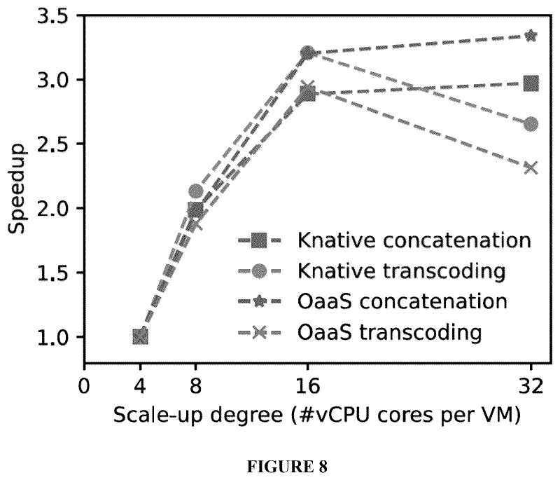

In this experiment, shown in FIG. 8, we observe that up to the 16 vCPUs per VM, the OaaS platform offers almost the same speedup as Knative. The reason is that the OaaS components are implemented multi-threaded with the non-blocking I/O that scales well in the multiple VM cores. The Figure also shows a speedup drop and a plateau for the scaleup to 32 vCPUs. Although part of this behavior is attributed to the Amdahl's law, we realized that our servers cannot host 32 vCPUs in one CPU socket, therefore, the overhead of memory access is increased. Another reason is that the performance variation increases on larger VMs that perturbs the efficacy of the load balancing method embedded in Knative. The reason that the speedup of string concatenation is less affected by this problem is that this function exhibits more data-intensive behavior, hence, it hits the TOPS bottleneck, instead of the processing bottleneck. The conclusion is that the OaaS scalability is comparable to Knative and the only limiting factors for both platforms are the physical machine limitations, and the task behavior.

Provided now is a real-world use case of an object development using the OaaS paradigm that demonstrates how it makes the development process of cloud-native serverless applications easier and faster. We discuss the details of implementing this use case via both FaaS and OaaS paradigms and demonstrate the advantages of OaaS over FaaS.

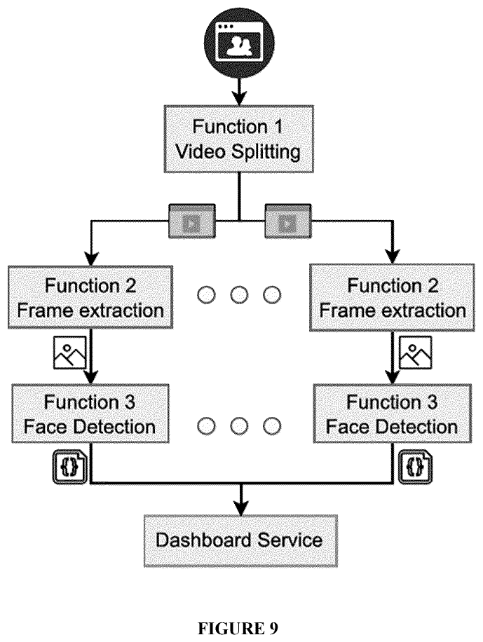

The use case is a video processing application that employs a machine learning model to perform face detection on the video contents. The detailed workflow of functions needed for this purpose, depicted in FIG. 9, includes a function (Function1) to split the input video into multiple video segments, that are processed concurrently on multiple instances of Function2 whose job is to extract the frames of each video segment. Then, Function3 is in charge of performing the face detection on the requested video frames and generating an object in the JSON format. These functions have to persist their output object on the storage so that the next function in the workflow can consume it.

To implement this use case in FaaS, the developer must implement the following steps: (i) Configuring a cloud-based object storage and maintaining the credential access token for the functions to use. (ii) The functions' business logic has to be implemented and configured to react to the trigger events. (iii) Data management within the functions that itself involves three steps: (a) allocating the storage addresses to fetch or upload data; (b) authenticating access to the object storage via the access token; and (c) implementing the fetch and upload operations on the allocated addresses.

Upon completing the implementation of the three functions, the developer has to connect them as a workflow via utilizing the function orchestrator service. Finally, the dashboard service invokes the workflow upon receiving a request from the end-user and collects the results.

On the other hand, implementing this use case in the OaaS paradigm involves defining three classes, namely Video, Image, and JSON_records in form of three classes with the following details: (a) Video class with video_splitting( ) and frame_extracting( ) functions; It also has a macro function, called wf_face_detect(detect_interval), that includes the whole workflow of function calls, with the requested face detection period as its input, and a JSON_record object, as the output. (b) Image class with the face_detection( ) function. (c) JSON_record class that does not require any function. In fact, the Dashboard Service invokes the wf_face_detect(detect_interval) macro function directly using the object access interface, and receives the JSON_record object as the output. We note that in developing the class functions, the developer does not need to involve in the data locating and authentication steps. In fact, the OaaS platform injects the preassigned URL of the state data into the event message of the task to enable the functions to fetch and upload the state data.

Thus, the OaaS paradigm aggregates the state storage and the function workflow in the platform and enables cloud-native dataflow programming. As such, the developers are relieved from the burden of learning the internal mechanics of multiple functions and pipelining them. Moreover, the OaaS paradigm removes the storage management logic from the developer code and relieves him/her from the state data management details, hence, the developer can only focus on the algorithm and the business logic.

In a further embodiment, the OaaS architecture comprises an object-based serverless platform comprising functionality to allow optimizations through scheduling the sequencing of tasks on the same machine. In a further embodiment, the OaaS allows an object to not comprise a persistent state. In a further embodiment, the OaaS supports the use of ephemeral objects.

The foregoing description sets forth exemplary methods, parameters, and the like. It should be recognized, however, that such description is not intended as a limitation on the scope of the present disclosure but is instead provided as a description of exemplary embodiments.

In the foregoing description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure. Such changes and modifications are to be understood as being included within the scope of the disclosure and examples as defined by the claims.

In addition, it is also to be understood that the singular forms “a,” “an,” and “the” used in the following description are intended to include the plural forms as well unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality.

However, all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing,” “computing,” “calculating,” “determining,” “displaying,” or the like refer to the action and processes of a computer system, or similar electronic computing device, that manipulates and transforms data represented as physical (electronic) quantities within the computer system memories or registers or other such information storage, transmission, or display devices.

Certain aspects of the present invention include process steps and instructions described herein in the form of an algorithm. It should be noted that the process steps and instructions of the present invention could be embodied in software, firmware, or hardware, and, when embodied in software, they could be downloaded to reside on, and be operated from, different platforms used by a variety of operating systems.

The present invention also relates to a device for performing the operations herein. This device may be specially constructed for the required purposes or it may comprise a general-purpose computer selectively activated or reconfigured by a computer program stored in the computer. Such a computer program may be stored in a non-transitory, computer-readable storage medium such as, but not limited to, any type of disk, including floppy disks, optical disks, CD-ROMs, magnetic-optical disks, read-only memories (ROMs), random access memories (RAMs), EPROMs, EEPROMs, magnetic or optical cards, application-specific integrated circuits (ASICs), or any type of media suitable for storing electronic instructions and each coupled to a computer system bus. Furthermore, the computers referred to in the specification may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention, as described herein.

The above description is presented to enable a person skilled in the art to make and use the disclosure, and it is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein.

We claim:

1. A system for managing one or more objects in a serverless cloud environment comprising:
an Object Control Module;
a Function Execution Module;
a Data Serving Module; and
a Data Management Module;
wherein an object comprises an immutable entity with a state associated with one or more functions;
wherein a state comprises application data;
wherein each function comprises a task comprising functionality to take action on a state;
wherein each function may comprise one or more inputs; and
wherein each input to the function may comprise one or more objects.

2. The system of claim 1, wherein each function is not capable of modifying any objects.

3. The system of claim 1, wherein the Object Control Module comprises:
an object controller;
a task manager; and
a storage adapter.

4. The system of claim 3, wherein the object controller comprises:
a handler;
a repository; and
a provision publisher.

5. The system of claim 3, wherein the Function Execution Module comprises:
a function queue;
a translator;
an API server;
one or more auto-scalers; and
a task completion handler;
wherein the task manager is in communication with the broker;

6. The system of claim 1, wherein the Data Management Module comprises:
a storage adapter; and
a state storage device.

7. The system of claim 1, wherein the Data Serving Module comprises a content delivery service.

8. A method for creating class and deploying its functions in a serverless cloud environment comprising:
a. providing a system for managing one or more objects in a serverless cloud environment comprising an Object Control Module and a Function Execution Module, wherein:
object comprises an immutable entity with a state associated with one or more functions;
a state comprises application data;
wherein each function comprises a task comprising functionality to take action on a state;
wherein each function may comprise one or more inputs; and
wherein each input to the function may comprise one or more objects;
b. initiating a script to deliver one or more specifications of a new function to the Object Control Module;
c. validating the one or more specifications by the Object Control Module; and
d. storing the one or more specifications in the Specifications Database;
e. publishing the one or more specifications in a messaging queue;
f. generating one or more resource definitions based upon the new function specification; and
g. submitting the one or more resource definitions to an API server.

9. The method of claim 8, wherein Object Control Module rejects the one or more specifications if the applicable specification is invalid.

10. The method of claim 8, wherein a controller synchronizes one or more resources of the API server.

11. A method for invoking a function of an object by an end user in a serverless cloud environment comprising:
a. providing a system for managing one or more objects in a serverless cloud environment comprising an Object Control Module, a Function Execution Module, a Data Serving Module, and a Data Management Module wherein:
an object comprises an immutable entity with a state associated with one or more functions;
a state comprises application data;
wherein each function comprises a task comprising functionality to take action on a state;
wherein each function may comprise one or more inputs; and
wherein each input to the function may comprise one or more objects;
b. requesting a resource by the end user;
c. requesting execution from a task manager by a content delivery service;
d. validating the execution request, loading an object specification from a Specifications Database, and generating a function execution task by the task manager;
e. submitting the task by the task manager to a broker;
f. routing the task to a requested function container;
g. soliciting an object state from a storage adapter via a URL in the request;
h. redirecting the task by the storage adapter to an actual object state in a state storage;
i. executing the function, production an output object state;
j. creating a new HTTP resource with the requested function and store in state storage through the URL;
k. informing a task completion handler of the completed task;

l. forming a completion event by the task completion handler;
m. sending the completion event to the task manager;
n. delivering the HTTP resource to the output object state location;
o. using the HTTP resource to retrieve the output object state from the state storage;
p. delivering the output object state to the end user.
